(19) United States
(12) Patent Application Publication
(10) Pub. No.: US 2022/0015169 A1
(43) Pub. Date: Jan. 13, 2022

(54) METHOD AND SYSTEM FOR DEVICE COMMUNICATION FOR USE IN WIRELESS COMMUNICATION SYSTEM

(71) Applicants: WU QI TECHNOLOGIES, INC., Chongqing (CN); SHANGHAI WU QI TECHNOLOGIES, INC., Shanghai City (CN)

(72) Inventors: Zhiyong XU, Chongqing (CN); Qijun LAN, Chongqing (CN)

(21) Appl. No.: 17/468,438

(22) Filed: Sep. 7, 2021

Related U.S. Application Data
(63) Continuation of application No. PCT/CN2021/075554, filed on Feb. 5, 2021.

(30) Foreign Application Priority Data
Dec. 26, 2019 (CN) 201911367968.7

(51) Int. Cl. H04W 76/14; H04L 1/18; H04W 4/80; H04W 76/30

(52) U.S. Cl. CPC H04W 76/14; H04W 76/30; H04W 4/80; H04L 1/1896

(57) ABSTRACT

A method and a system for device communication for use in a wireless communication system. The method comprises: S100, causing a secondary device to establish a link for communication between a primary device and a host device; S200, the secondary device and the primary device negotiating to enter an acknowledgment monitoring mode, the monitoring link entering the acknowledgment monitoring mode, and the primary device and the host device entering the acknowledgment monitoring mode; and S300, completing information exchange, and then the communication link between the secondary device and the primary device exiting the acknowledgment monitoring mode. The system comprises a primary device, a secondary device, and a host device, all carrying a Bluetooth communication protocol. In the present invention, the removal of one link is able to reduce the power consumption of a primary device and a secondary device, reducing the burden and expenses of the devices, and improving user experience.

### TECHNICAL FIELD

The present invention relates to Bluetooth communication technology, and specifically relates to a method and a system for device communication for use in a wireless communication system.

### BACKGROUND

Wireless communication, based on radio waves, microwaves, and IR, transmits among multiple nodes without conductors or cables. Wireless communication technologies include Bluetooth, Zig-Bee, and Z-Wave. At present, the fast pace of life has promoted the development of voice message interaction with Bluetooth. Bluetooth headphones are one of the important products using Bluetooth technology for voice message interaction.

The dual wireless Bluetooth headset includes two headphones, which form a wireless communication system with the host device (such as mobile phone, tablet and computer) and synchronously play the music from the host device or make a call. At present, the solutions to the communication between the two headphones of the dual wireless Bluetooth headset include the following:

The first one is: Bluetooth headset includes a primary headphone and a secondary headphone. When communicating with Bluetooth headset, the host device only communicates with the primary headphone. A Bluetooth communication link is established between the primary headphone and the secondary headphone. The primary headphone forwards the music or call data of the host device to the secondary headphone. The existing Bluetooth protocol can provide support, but the primary headphone needs to interact with the host device with a large amount of data, and also needs to forward a large amount of data to the secondary headphone. The power consumption of the primary headphone will be much larger than that of the secondary headphone, and the play quality of the secondary headphone depends on the primary headphone.

The second one is: modification of the Bluetooth A2DP protocol, in which the host device establishes two A2DP links and communicates and interacts data with the primary headphone and the secondary headphone respectively. It saves power consumption and has no mutual effect between the primary headphone and the secondary headphone. However, the Bluetooth protocols of the host device, the primary headphone and the secondary headphone have to be modified, and the adaptability is poor, making it difficult to popularize on a large scale.

The third one is: snoop mode, where the secondary headphone listen the data packet sent by the host device to the primary headphone, and then replies ACK to the primary headphone by using Bluetooth time slot gap, and the ACK informs the primary headphone whether the secondary headphone receives the data packet of the host device. The secondary headphone can only reply to the primary headphone whether the packet is received, but cannot support the listening of Bluetooth Link Manager Protocol (LMP) content bidirectional interaction. The snoop link cannot be maintained by simply listening, and the primary headphone also needs an extra BT link or BLE link to inform the secondary headphone of the change of LMP content between the host device and the primary headphone, increasing extra link overhead in software and hardware.

### SUMMARY OF THE INVENTION

The present invention is intended to provide a method for device communication for use in a wireless communication system, so as to realize low power consumption and high adaptability of the earphone without any modification by the host device, forwarding of voice or call data by the primary headphone, and long-term maintenance of an extra link between the primary headphone and the secondary headphone.

The method for device communication for use in a wireless communication system in this scheme includes the following steps:

S100, ask the secondary device to establish a Shadow link for communication between the primary device and the host device;

S200, the secondary device negotiates with the primary device to enter the ACK Shadow mode, the Shadow link of the secondary device enters the ACK Shadow mode, and the primary device and the host device enter the ACK Shadow mode. The ACK Shadow mode mentioned is that the primary device or the secondary device receives the messages sent by the host device, and then the primary device continuously receives the ACK sent by the secondary device. According to the receiving situation of the two devices, the primary device replies the host device in the next communication time slot;

S300, after information interaction, the exit the normal BT link between the primary device and the secondary device link between the primary device and the secondary device exits the ACK monitoring mode.

The beneficial effects of the scheme are as follows: Ask the primary device, secondary device and host device to enter the ACK Shadow mode, and ask the secondary device to send whether to receive the ACK of communication data in the communication time slot. For example, the secondary device acting as the secondary headphone of the Bluetooth headset receives a music data packet sent by a mobile phone as a host device, and then the secondary device sends it to the primary headphone of the Bluetooth headset as a reception ACK of the primary device. The primary device replies the ACK to the host device in the next communication time slot according to the receiving conditions of two devices (primary device and secondary device). For example, if both primary device and secondary device have received the packet sent by the host device, the primary device will send ACK as a reply, if one of these two device has not received a certain packet, the primary device will send NACK as a reply; when transmitting data in the communication time slot, it is based on the length of the data packet between the host device and the primary device in the communication time slot, which is possible to add several milliseconds of retransmission between the host device and the primary device, and will not affect the transmission of the ACL asynchronous link. The delay of several milliseconds is equivalent to that of the transmission of the data packet between the host device and the primary device to the next communication time slot. During synchronous link transmission of the host device and the primary device, the primary device and the secondary device can only interact with short packets, which does not affect synchronization link. The communication of link management data between the primary device and the secondary device does not need to occupy a single communication link at the same time. Compared with the existing Bluetooth communication mode, the removal of one link is able to reduce the power consumption of the primary device and the secondary device, reducing the burdens and expenses of the devices, and improving user experience.

Furthermore, if the communication of one device is terrible, after information interaction, the communication link between the primary device and the secondary device exit the ACK Shadow mode. the method of exiting the ACK Shadow mode mentioned is exit upon interaction between the primary device and the secondary device through Bluetooth private communication protocol.

The beneficial effects are that the exit process is smoother and the synchronization between the primary device and the secondary device is better. Exiting the ACK Shadow mode will not affect the communication between the host device and the primary device. For example, when exiting the ACK Shadow mode, it will not affect the primary device to play music, but do affect the secondary device to play music. For example, for a call, neither the primary device nor the secondary device is affected.

Furthermore, the method of exiting the ACK Shadow mode mentioned is disconnection of the secondary device.

The beneficial effects are that the primary device can receive the communication data again, and its call and music playing are not affected.

The information interaction mentioned involves the long packet data and short packet data, the long packet data includes the link management data, and the short packet data mentioned includes ACK.

The beneficial effects are that the information interaction is based on short packet data or long packet data, which can ensure the complete transmission of corresponding data in the communication time slot and reduce the occupied length of the communication time slot.

Furthermore, the reply messages mentioned are sent in the communication time slot after a period of time upon receiving ACK.

The beneficial effects are that reply messages are sent in the next communication time slot, and the communication time slot will be occupied if reply messages are sent again after the short packet data is sent, thus preventing the long packet data of reply messages from occupying the communication time slot.

The method and system for device communication for use in a wireless communication system include primary device, secondary device and host device based on Bluetooth communication protocol. The primary device mentioned includes primary processing module, the secondary device mentioned includes the secondary processing module, the secondary processing module mentioned establishes a Shadow link for primary device and host device, the secondary processing module negotiates with the primary processing module to enter the ACK Shadow mode, the Shadow link mentioned enters the ACK Shadow mode, the primary processing module and the host device enter the ACK Shadow mode, and the secondary processing module exits the normal BT communication link with primary processing module after information interaction.

The beneficial effects of the scheme are that the secondary processing module of the secondary device negotiates with the primary processing module of the primary device to enter the ACK Shadow mode. For example, the processing modules inside the secondary headphone and the primary headphone of Bluetooth headset negotiate to enter the ACK Shadow mode by sending messages, and then perform information interaction in the communication time slot, and exits the normal BT communication link after information interaction, that is, the primary headphone and the secondary headphone will not always occupy a communication link for information interaction. Compared with the existing Bluetooth communication mode, the removal of one link is able to reduce the power consumption of the primary device and the secondary device, reducing the burdens and expenses of the devices, prolonging the time for continuous use of the primary device and the secondary device and improving user experience.

Furthermore, the ACK Shadow mode mentioned is that the sender sends ACK in the communication time slot and receives reply messages of the replier in the next communication time slot, the sender of ACK mentioned includes secondary device or primary device, and the replier of reply messages mentioned includes primary device or secondary device.

The beneficial effects are that each interactive message between the primary device and the secondary device is transmitted in one communication time slot, which does not occupy the communication time slot of the system. For example, it does not occupy the transmission time slot for transmitting the music data packet, causing no interference and occupying no separate communication link. The energy consumption between the primary device and the secondary device is the same.

Furthermore, the secondary processing module mentioned exits the ACK Shadow mode with the primary processing module upon interaction through Bluetooth private communication protocol.

The beneficial effects are exiting upon interaction through protocol. For example, the secondary processing module sends an exit message to the primary processing module, and the secondary processing device and the primary processing device exit the ACK Shadow mode, without suspending the communication between the secondary processing device and the primary processing device, improving the user experience.

Furthermore, the secondary processing module mentioned exits the ACK Shadow mode through disconnection with the communication link of Bluetooth of the primary processing module.

The beneficial effects are that the ACK Shadow mode is exited by disconnecting the communication link between the secondary processing device and the primary processing device. Under the sudden link disconnection, the communication data can be retransmitted. For example, the music data packet played by the primary processing device is retransmitted, and the primary processing module keeps the original call or music play.

### BRIEF DESCRIPTION OF THE DRAWINGS

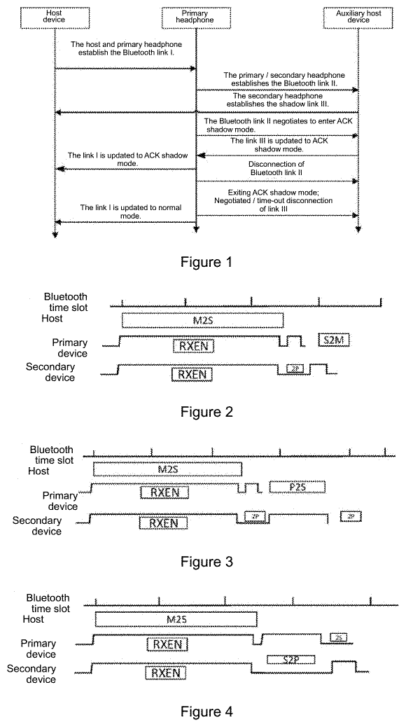

The flow chart of Shadow link with the method for device communication for use in a wireless communication system in Embodiment 1 of the present invention is shown in FIG. 1;

The time slot diagram of no new data transmission between the primary headphone and the secondary headphone when the host device acts as the sending end in the method for device communication for use in a wireless communication system in Embodiment 1 of the present invention is shown in FIG. 2;

The time slot diagram of new data transmission by the primary headphone when the host device acts as the sending end in the method for device communication for use in a wireless communication system in Embodiment 1 of the present invention is shown in FIG. 3;

The time slot diagram of new data transmission by the secondary headphone when the host device acts as the sending end in the method for device communication for use in a wireless communication system in Embodiment 1 of the present invention is shown in FIG. 4;

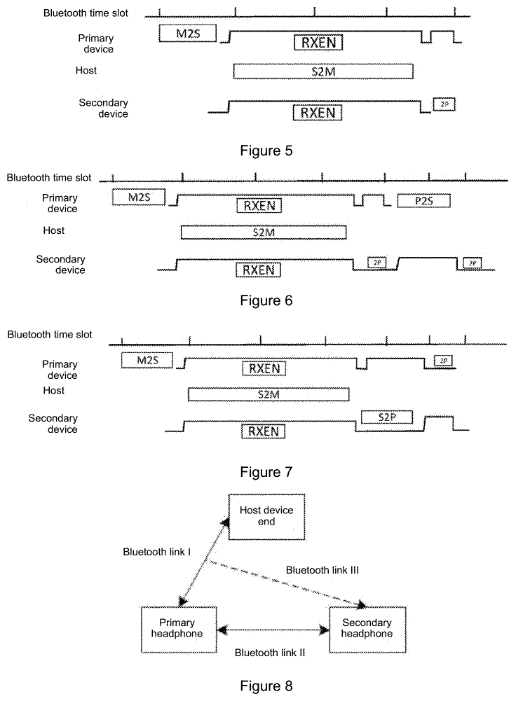

The time slot diagram of no new data transmission between the primary headphone and the secondary headphone when the host device acts as the receiving end in the method for device communication for use in a wireless communication system in Embodiment 1 of the present invention is shown in FIG. 5;

The time slot diagram of new data transmission by the primary headphone when the host device acts as the receiving end in the method for device communication for use in a wireless communication system in Embodiment 1 of the present invention is shown in FIG. 6;

The time slot diagram of new data transmission by the secondary headphone when the host device acts as the receiving end in the method for device communication for use in a wireless communication system in Embodiment 1 of the present invention is shown in FIG. 7;

The principle block diagram of the system for device communication for use in a wireless communication system in Embodiment 1 of the present invention is shown in FIG. 8;

### SPECIFIC IMPLEMENTATION MODE

The following is further described in detail through the specific implementation mode:

### Embodiment I

As shown in FIG. 8, the system for device communication for use in a wireless communication system includes primary device, secondary device and host device equipped with Bluetooth communication protocol. The primary device is the primary headphone in Bluetooth headset, and the secondary device is the secondary headphone in Bluetooth headset. The primary device includes primary processing module, and the secondary device includes secondary processing module. The existing CSR8645 Bluetooth module can be used for the primary processing module and the secondary processing module, and the host device can be the mobile phone or computer.

As shown in FIG. 1, the method for device communication for use in a wireless communication system based on the method for device communication for use in a wireless communication system includes the following steps:

S100, the communication link established between the primary device and the host device through the primary processing module is defined as Bluetooth link 1, that is, the communication link between the primary headphone and the mobile phone is Bluetooth link 1; the communication link established between the primary device and the secondary processing module of the secondary device through the primary processing module is defined as Bluetooth link 2; the primary device sends the data packet of Bluetooth link 1 to the secondary device through Bluetooth link 2, that is, the primary headphone sends the data packet received from the mobile phone to the secondary headphone; the data packet includes the link management information, such as Bluetooth address, clock information, frequency-hopping information and encryption key of the host device, so that the secondary device establishes a Shadow link for the communication between the primary device and the host device, and the Shadow link is defined as Bluetooth link 3, that is, the secondary headphone obtains the voice information sent by the mobile phone to the primary headphone in Shadow by the Shadow link, such as music or call information;

S200, the secondary processing module of the secondary device negotiates with the primary processing module of the primary device to enter the ACK Shadow mode, that is, Bluetooth link 2 negotiates to enter the ACK Shadow mode. The secondary processing module negotiates by sending a data packet of entering the ACK Shadow mode to the primary processing module, for example, the secondary processing module sends an entry ACK to the primary processing module, and the Shadow link of the secondary device enters the ACK Shadow mode, that is, Bluetooth link 1 and Bluetooth link 3 enter the ACK Shadow mode. The ACK Shadow mode is that the sender sends the ACK in the communication time slot and receives reply messages of the replier in the next communication time slot. The sender can be the primary device or the secondary device, and the receiver can be the secondary device or the primary device;

S300, after information interaction, the communication link between the secondary device and the primary device exits the normal BT communication link.

The ACK Shadow mode in the above steps is that the sender sends the ACK in the communication time slot and receives reply messages of the replier in the next communication time slot. The ACK includes whether the communication data or the replied short packet data is received, and reply messages include the short packet data replied according to the short packet data or the long packet data of the link management data. For example, taking the primary device as the primary headphone, the secondary device as the secondary headphone, and the host device as the sending end or receiving end, the several communication situations of the primary device, secondary device and host device under the ACK Shadow mode are as follows:

(1) As the sending end, the host device is defined as Master, the primary headphone is defined as Primary, the secondary headphone is defined as Secondary, and the primary headphone interacts with secondary headphone with short packet.

As shown in FIG. 2, in Bluetooth link 1, when there is no long packet interaction between the primary headphone and the secondary headphone, the primary headphone and the secondary headphone synchronously enable receiving of the data packet of the host device, and the data packet can be the music data packet sent by the host device. After receiving the data packet from the headphone, and a certain interval, the interval can be the next communication time slot. The secondary headphone replies the short packet to the primary headphone. If the short packet confirms that the data packet is received (ACK) or the data packet is not received (NACK), the primary headphone judges whether the data packet of the host device is received from the headphone according to the content of the received short packet, and then in the next Bluetooth time slot, the primary headphone replies ACK according to receiving of the data packet of the host device by itself and the data packet of the host device by the secondary headphone.

(2) As the sending end, the host device is defined as Master, the primary headphone is defined as Primary, the secondary headphone is defined as Secondary, and the primary headphone interacts with secondary headphone with long packet.

As shown in FIG. 3, during the data interaction between the primary headphone and the host device, when the primary headphone send a long packet to the secondary headphone, the long packet can include link management data, for example, Bluetooth address, clock information, frequency-hopping information and encryption key of the host device. After the primary headphone and the secondary headphone receive the data packet of the host device, the secondary headphone replies the short packet to the primary headphone to notify the reception of the primary headphone, and the short packet can be ACK. After the primary headphone receives the short packet of the secondary headphone, the primary headphone replies a long packet to the secondary headphone at an interval of time. After receiving the long packet, the secondary headphone replies a short packet to confirm the reception of the above long packet.

As shown in FIG. 4, during the data interaction between the primary headphone and the host device, when the primary headphone sends a long packet to the secondary headphone, after the primary headphone and the secondary headphone receive the data packet of the host device, the secondary headphone sends the long packet to the primary headphone. The primary headphone detects whether it is a short packet or a long packet in real time according to the received packet content. After detecting the long packet, the primary headphone extends the receiving window to complete receiving of the long packet, and then, the primary headphone replies a short packet (for example, ACK) to the secondary headphone to confirm the receiving of the above long packet.

(3) As the receiving end, the host device is defined as Slave, the primary headphone is defined as Primary, the secondary headphone is defined as Secondary, and the primary headphone interacts with secondary earphone with short packet.

As shown in FIG. 5, in Bluetooth link I, the secondary headphone ignores the data packet sent by the primary headphone to host device. When the host device begins to send the data packet, the secondary headphone enables receiving, in case of no long packet interaction demand between the primary headphone and secondary headphone, the secondary headphone sends the short packet to the primary headphone after receiving the data packet of host device, the primary headphone immediately enables receiving of the short packet of secondary headphone after receiving the data packet of host device, and judge whether it is short packet or long packet according to the contents of short packet and the receiving of secondary headphone to determine to reply ACK of host device later.

(4) As the receiving end, the host device is defined as Slave, the primary headphone is defined as Primary, the secondary headphone is defined as Secondary, and the primary headphone interacts with secondary headphone with long packet.

As shown in FIG. 6, during the interaction between host device and primary headphone, when the primary headphone sends the long packet to the secondary headphone, similar to the condition of the host device being the sending end, after receiving the data packet of host device by both headphones, the secondary headphone sends the short packet to the primary headphone first, and then the primary headphone sends the long packet to the secondary headphone, and the secondary headphone replies ACK finally to confirm receiving of the above long packet.

As shown in FIG. 7, during the interaction between host device and primary headphone, when the secondary headphone sends the long packet to the primary headphone, after correctly receiving the data packet of host device by both headphones, the secondary headphone directly sends the long packet to primary headphone, the primary headphone immediately detects the long packet received after receiving the data packet of host device, and replies ACK after receiving the long packet sent by the secondary headphone to confirm receiving of the above long packet.

In the figures mentioned above, “M2S” and “S2M” in the figures refer to “data interaction between host device and primary device”, “P2S”, “2P” and “2S” refer to “data interaction between the primary device and the secondary device”, of which “2” indicates “to”, for example, “2P” indicates “information sent to the primary device” and “2S” indicates “information sent to the secondary device”, and “RXEN” refers to the data packet sent by the host device.

In Embodiment I, cancel the special link that transfers link management information in existing technology through the transmission of link management information in communication time slot by the secondary headphone via ACK Shadow mode, and exit the mode through private protocol upon transmission of corresponding link management information, so that the primary headphone and the secondary headphone can restore the normal data interaction mode. The removal of one link is able to reduce the power consumption of the primary headphone and the secondary headphone, reducing the burdens and expenses of the devices, and improving user experience.

### Embodiment II

The difference from Embodiment I is that the mode of exiting the ACK Shadow mode is secondary device disconnection, the secondary device is secondary headphone, the secondary processing module of secondary headphone exits the ACK Shadow mode by disconnecting the communication link with primary processing module. The secondary processing module can disconnect the communication link with primary processing module by increasing the distance between primary headphone and secondary headphone, that is, the user takes off the secondary headphone to increase the distance between primary headphone and secondary headphone, or the secondary headphone is separated with the user's ear due to other causes. Under the condition of sudden disconnection of communication link between primary headphone and secondary headphone, the communication data of primary headphone can be re-transferred by host device, for example, re-transfer the music data packet of primary headphone playing currently, to hold the original call or music play of primary processing module.

The above mentioned is only an embodiment of the invention, and the common sense such as the specific structure and characteristics known in the scheme is not described too much here. It shall be pointed out that for those skilled in the field, a number of modifications and improvements can be made without departing from the structure of the invention, which shall also be regarded as protection scope of the invention and will not affect the implementation effect of the invention and practicability of the patent. The protection range required by the application shall be subject to the contents of Claims, and the specific implementation mode and other records in the specification can be used to explain the contents of Claims.

1. It is a method for device communication for use in a wireless communication system, and its characteristics include the following steps:
S100, ask the secondary device to establish a Shadow link for communication between the primary device and the host device;
S200, the secondary device negotiates with the primary device to enter the ACK Shadow mode, the Shadow link of the secondary device enters the ACK Shadow mode, and the primary device and the host device enter the ACK Shadow mode. The ACK Shadow mode mentioned is that the primary device or the secondary device receives the messages sent by the host device, and then the primary device continuously receives the ACK sent by the secondary device. According to the receiving situation of the two devices, the primary device replies the host device in the next communication time slot;
S300, after information interaction, the communication link between the secondary device and the primary device exits the normal BT communication link.

2. According to the method for device communication for use in a wireless communication system mentioned in claim 1, its characteristic is: The mode of exiting the ACK Shadow mode is to exit upon interaction between the primary device and the secondary device through Bluetooth private communication protocol.

3. According to the method for device communication for use in a wireless communication system mentioned in claim 1, its characteristic is: The mode of exiting the ACK Shadow mode mentioned is secondary device disconnection.

4. According to the method for device communication for use in a wireless communication system mentioned in claim 1, its characteristic is: The information interaction mentioned involves the long packet data and short packet data, the long packet data includes the link management data, and the short packet data mentioned includes ACK.

5. According to the method for device communication for use in a wireless communication system mentioned in claim 4, its characteristic is: Reply messages mentioned are sent in the communication time slot after a period of time upon receiving ACK.

6. The system for device communication for use in a wireless communication system includes primary device, secondary device and host device based on Bluetooth communication protocol. The primary device mentioned includes primary processing module, the secondary device mentioned includes the secondary processing module, the secondary processing module mentioned establishes a Shadow link for primary device and host device, the secondary processing module negotiates with the primary processing module to enter the ACK Shadow mode, the Shadow link mentioned enters the ACK Shadow mode, the primary processing module and the host device enter the ACK Shadow mode, and the secondary processing module exits the ACK Shadow mode of communication link with primary processing module after information interaction.

7. According to the system for device communication for use in a wireless communication system mentioned in claim 1, its characteristic is: The ACK Shadow mode mentioned is that the sender sends ACK in the communication time slot and receives reply messages of the replier in the next communication time slot, the sender of ACK mentioned includes secondary device or primary device, and the replier of reply messages mentioned includes primary device or secondary device.

8. According to the system for device communication for use in a wireless communication system mentioned in claim 1, its characteristic is: The secondary processing module mentioned exits the ACK Shadow mode with the primary processing module upon interaction through Bluetooth private communication protocol.

9. According to the system for device communication for use in a wireless communication system mentioned in claim 1, its characteristic is: The secondary processing module mentioned exits the ACK Shadow mode through disconnection with the communication link of Bluetooth of primary processing module.
